(19) United States
(12) Patent Application Publication
(10) Pub. No.: US 2003/0088453 A1
(43) Pub. Date: May 8, 2003

(54) System, method and computer program product for rank assignment

(75) Inventor: Toshio Ueno, Hanno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/002,740

(22) Filed: Nov. 2, 2001

(51) Int. Cl. G06F 17/60

(52) U.S. Cl. 705/10

(57) ABSTRACT

A rank assignment system receives input of a complaint from a web page provided as an input/output interface of information, calculates points for each analysis-determination item used to analyze and determine the complaint, on the basis of the result obtained by analyzing product information, held by a matter data base section, related to a sales product, and a preset condition for the result, then totals the points calculated for the analysis-determination items, and assigns a rank to the complaint on the basis of the totaled points and a preset point range.

### BACKGROUND OF THE INVENTION

1. Field of the Invention

The present invention relates to a rank assignment method and system for assigning ranks to various product complaints from a worldwide technical service network, and a computer-readable recording medium which stores a program for operating the rank assignment system and method.

2. Description of the Related Art

In recent years, many large corporations have local companies abroad as product sales bases. In a typical large corporation, these local companies sell products to end users through, e.g., agencies and dealers. Technical services such as maintenance and repair of sales products are provided from dealers and direct service organizations to end users. Local head offices relay various complaints received directly from the dealers and direct service organizations or indirectly through the agencies and local companies to the technical service department of the head office.

The technical service department plays the role of mediator between the local companies, i.e., customers, and the product technology departments of factories or deliverers. The technical service department requests a solution to a complaint relayed by a local company from an engineer in charge in the product technology department. The engineer in charge then executes a support operation and confirms the contents of the complaint, investigates the cause of the problem, and searches for a solution. The technical service department confirms the solution informed by the engineer in charge, creates a complaint schedule, and notifies this to the above-described local corporation as an answer to the problem.

The dealers, direct service organizations, agencies, local companies, local head offices, technical service department, factories, and deliverers are connected through dedicated lines or Internet lines to form, e.g., a hierarchical structure as shown in FIG. 1. E-mail is used as the information transmission medium.

In the support operation of examining a solution to solve a complaint, each service layer routinely searches a database for a solution to a complaint sent by E-mail from a lower service layer. If no solution is found, it is requested of an upper service layer. Hence, complaint reports steadily build up in the shift from the lowermost service layer to the uppermost service layer. For example, since the technical service department receives all the complaint reports from local head offices that handle various markets in different areas, the layer-shifted complaint reports easily build up.

As described above, the technical service department must execute the support operations for many complaints with limited manpower. For more efficient operations, the technical service department receiving complaint reports from the local head offices notifies them to assign ranks such as A, B, C, . . . , representing degrees of importance, to the complaints, to expedite them respectively. Upon receiving complaint reports with the assigned ranks of importance, the technical service department sequentially executes support operations preferentially from complaints of rank A.

However, the local head offices desire the technical service department to expedite the support operation in order to satisfy the customer. Additionally, the local head offices hold only information related to products in the relevant areas and cannot determine the degrees of importance. For these reasons, the local head offices send most complaint reports as rank A to the technical service department. Since the technical service department receives these rank A complaints, the ranking system that aims at executing the support operation according to degrees of importance does not work. Hence, to determine the degrees of priority of complaint handling, the technical service department must assign ranks appropriately representing the degrees of importance to complaint reports shifted from the lower service layers.

### BRIEF SUMMARY OF THE INVENTION

According to an aspect of the invention, there is provided a rank assignment system comprises a service information portal section which provides a web page as an input/output interface of information and receives a complaint from the web page, a master database section which holds product information related to a sales product, a point calculation section which calculates points for each analysis-determination item used to analyze and determine the complaint, on the basis of a result obtained by analyzing the product information and a preset condition for the result, and totals the points of the analysis-determination items; and a rank assignment section which assigns a rank to the complaint on the basis of the points totaled by the point calculation section and a preset point range.

There is also provided a rank assignment method comprises receiving input of a complaint from a web page which is provided as an input/output interface of information, calculating points for each analysis-determination item used to analyze and determine the complaint, on the basis of a result obtained by analyzing product information related to a sales product, which is held by a master database section, and a preset condition for the result, totaling the points calculated for the analysis-determination items, and assigning a rank to the complaint on the basis of the totaled points and a preset point range.

### BRIEF DESCRIPTION OF THE SEVERAL VIEWS OF THE DRAWING

The accompanying drawings, which are incorporated in and comprise a part of the specification, illustrate embodiments of the present invention and, together with the general description given above and the detailed description of the embodiments given below, serve to explain the principles of the present invention.

FIG. 1 is a view showing the hierarchical structure of a technical service according to an embodiment of the present invention;

FIG. 2 is a block diagram showing the configuration of a rank assignment system of the embodiment and a network connected to the system;

FIG. 3 is a table showing the analysis-determination items of the rank assignment system according to the embodiment;

FIG. 4 is a table showing points calculated from analysis-determination of the delivery situation of a defective service part in the embodiment;

FIG. 5 is a table showing points calculated from analysis-determination of the machine market operation reliability of a defective product in the embodiment;

FIG. 6 is a table showing points calculated from analysis-determination of the report situation to the call center about occurrence of complaints that are the same as a given complaint in the embodiment;

FIG. 7 is a table showing points calculated from analysis-determination of the identical problem situation of maintenance service information about occurrence of complaints that are the same as a given complaint in the embodiment;

FIG. 8 is a table showing points calculated from analysis-determination of the setup report situation about occurrence of complaints that are the same as a given complaint in the embodiment;

FIG. 9 is a table showing points calculated from analysis-determination of the compensation situation of a defective product in the embodiment;

FIG. 10 is a table showing points calculated from analysis-determination of the product sales situation and inventory situation of a defective product in the last month and in the total period in the embodiment;

FIG. 11 is a table showing points calculated from analysis-determination of the download situation of firmware and drivers corresponding to a complaint in the embodiment;

FIG. 12 is a table showing a weight setting table according to the embodiment;

FIG. 13 is a table showing a rank assignment table according to the embodiment; and

FIG. 14 is a flowchart showing the flow of processing executed by the rank assignment system according to the embodiment.

### DETAILED DESCRIPTION OF THE INVENTION

An embodiment of the present invention will be described below with reference to the accompanying drawing.

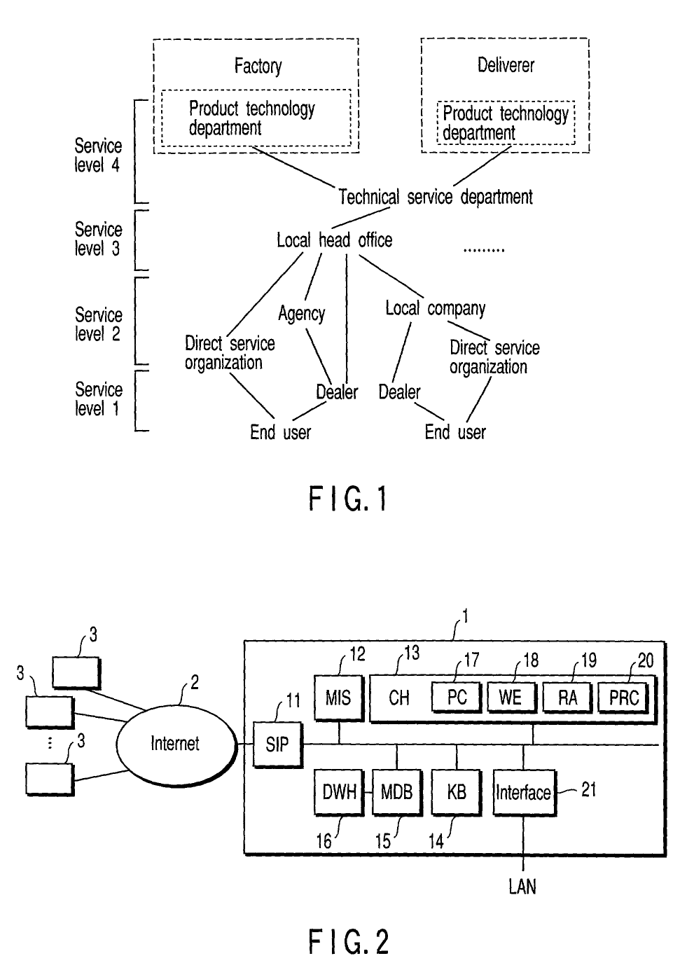

The rank assignment system is, e.g., a server arranged in the technical service department having the technical service department hierarchical structure shown in FIG. 1. This rank assignment system is connected to a network for customers, i.e., local head offices in the world which serve as sales bases of products such as copying machines and facsimile apparatuses and play a role of mediating between the customers and the product technology departments of factories or deliverers for employees of the technical service department.

FIG. 2 is a block diagram showing the configuration of a rank assignment system 1 and a network connected to the rank assignment system 1. The rank assignment system 1 is connected to terminal apparatuses 3 of local head offices, i.e., customers through a network, e.g., the Internet 2.

This rank assignment system 1 has a service information portal (SIP) section 11, management information system (MIS) section 12, complaint handling (CH) section 13, knowledgebase (KB) section 14, master database (MDB) section 15, data warehouse (DWH) section 16, and communication interface section 21. The CH section 13 includes a point calculation (PC) section 17, weight setting (WE) section 18, rank assignment (RA) section 19, and point range change (PRC) section 20.

The SIP section 11, MIS section 12, CH section 13, KB section 14, MDB section 15, DWH section 16, and communication interface section 21 are formed from, e.g., a server computer connected through a common system bus. However, these components may be formed from a plurality of server computers.

The SIP section 11 serving as an information input/output interface provides a web page to the customer terminals 3 on the Internet 2. When a complaint report is input to the web page, the SIP section 11 receives the complaint. The complaint report is created by inputting information to specify the complaint, such as a product number and malfunction portion.

The MIS section 12 accesses the customer terminals 3 through the SIP section 11 to collect and analyze report information. The report information contains, e.g., warranty report data, call center data, setup report data, service parts use data, and complaint report data accumulated on the side of the customer terminals 3.

The CH section 13 registers new complaint reports in the KB section 14 and manages unsolved complaints which require answers from engineers in the product technology departments.

The KB section 14 holds complaint reports which are also backed up by the MDB section 15, and solutions to the complaint reports, returned from engineers in the product technology departments. The KB section 14 also holds area-specific information supplied from an intra-office LAN and center information held by the technical service department.

The MDB section 15 holds the report information and other information collected by the MIS section 12 altogether as product information. When new information is collected, the MDB section 15 updates the held product information. The MDB section 15 holds, as product information, e.g., the number of delivered service parts, the number of delivered products, the total number of copies, the number of service calls, the number of reports (inquiries), the number of maintenance result reports, the number of setup reports, the total amount of compensation, the sales record for the last month, the sales forecast for the month, the sales record for the total period, the sales forecast for the total period, and the number of downloads of firmware and drivers corresponding to a complaint for each sales product. The MDB section 15 also holds, as product information, e.g., the total number of copies, the number of service calls, the number of reports (inquiries), the number of maintenance result reports, and the number of setup reports for all the sales products.

The DWH section 16 holds a formula used by the MIS section 12 to analyze the information held by the MDB section 15.

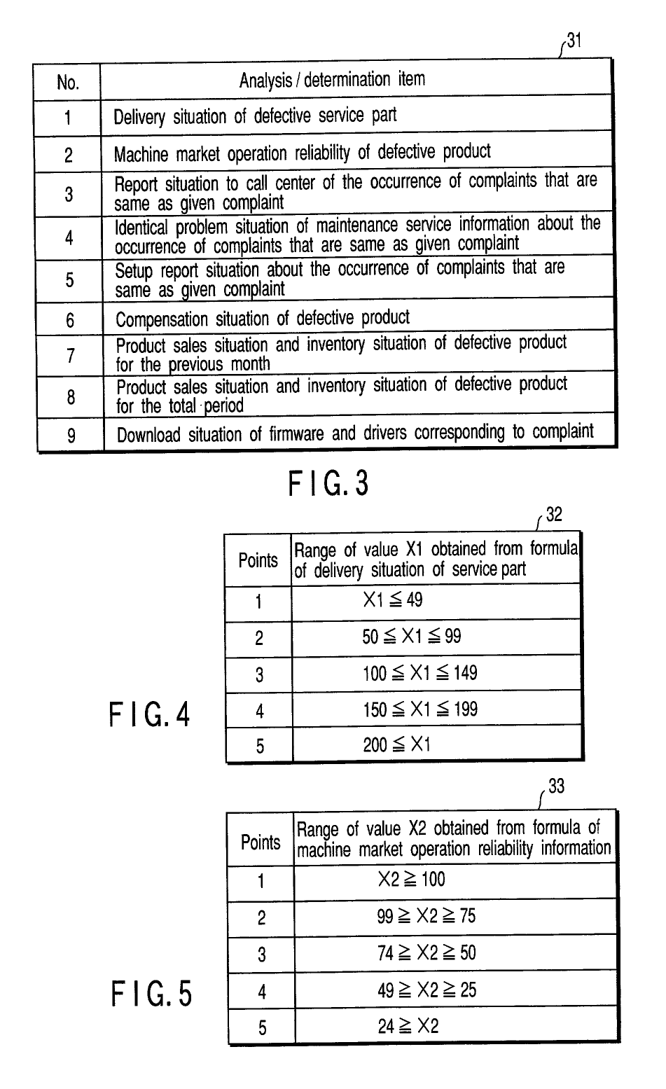

The PC section 17 analyzes and determines a complaint specified by a complaint report. As items to be used for this analysis-determination, nine analysis-determination items are prepared in, e.g., a table 31 shown in FIG. 3. Item No. (number) 1 is the delivery situation of a defective service part. Item No. 2 is the machine market operation reliability of a defective product. Item No. 3 is the report situation to the call center of the occurrence of complaints that are the same as a given complaint. Item No. 4 is the identical problem report situation of maintenance service information about the occurrence of complaints that are the same as a given complaint. Item No. 5 is the setup report situation about the occurrence of complaints that are the same as a given complaint. Item No. 6 is the compensation situation of a defective product. Item No. 7 is the product sales situation and inventory situation of a defective product for the previous month. Item No. 8 is the product sales situation and inventory situation of a defective product for the total period. Item No. 9 is the download situation of firmware and drivers corresponding to a complaint.

The PC section 17 also assigns e.g., 1 to 5 points for each analysis-determination item in a target market using formulas to be described below and tables used to calculate a point from calculation results of the formulas set for each analysis-determination item. In each analysis-determination item, when the degree of importance of early complaint handling is high in the market, a high number of points is calculated. The analysis-determination items will be described below.

The delivery situation of a defective service part, which is analyzed and determined in analysis-determination item No. 1, is obtained by, e.g., formula: (the number of delivered service parts/the number of delivered products using the parts)×100. Assume that the calculation result of this formula is X1%. The PC section 17 calculates points on the basis of table 32 shown in FIG. 4 that shows points calculated from the value X1. When X1≦49, the PC section 17 calculates 1 point. When 50≦X1≦99, the PC section 17 calculates 2 points. When 100≦X1≦149 , the PC section 17 calculates 3 points. When 150≦X1≦199, the PC section 17 calculates 4 points. When 200≦X1, the PC section 17 calculates 5 points.

The machine market operation reliability of a defective product, which is analyzed and determined in analysis-determination item No. 2, is obtained by, e.g., calculating the mean number of service call occurrence interval copies (MCBSC) by the total number of copies for all machines/the total number of service calls, and comparing the calculated value with the average for another product. That is, the machine market operation reliability of a defective product is obtained by the formula: (the MCBSC of the product/the mean MCBSC of another product)×100. Assume that the calculation result of this formula is X2%. The PC section 17 calculates points on the basis of table 33 shown in FIG. 5 that shows points calculated from the value X2. When X2≧100, the PC section 17 calculates 1 point. When 99≧X2≧75, the PC section 17 calculates 2 points. When 74≧X2≧50, the PC section 17 calculates 3 points. When 49≧X2≧25, the PC section 17 calculates 4 points. When 24≧X2, the PC section 17 calculates 5 points.

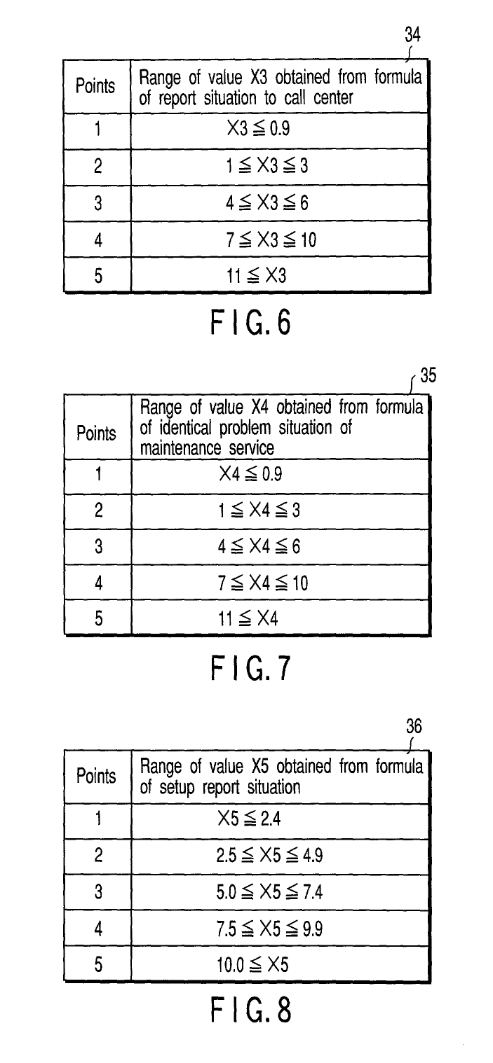

The report situation to the call center of the occurrence of complaints that are the same as a given complaint, which is analyzed and determined in analysis-determination item No. 3, is obtained by, e.g., formula: {the number of reports (inquiries) about complaints that are the same as a given complaint/the total number of reports (inquiries)}×100. Assume that the calculation result of this formula is X3%. The PC section 17 calculates a point on the basis of a table 34 shown in FIG. 6 that shows points calculated from the value X3. When X3≦0.9, the PC section 17 calculates 1 point. When 1≦X3≦3, the PC section 17 calculates 2 points. When 4≦X3≦6, the PC section 17 calculates 3 points. When 7≦X3≦10, the PC section 17 calculates 4 point. When 11≦X3, the PC section 17 calculates 5 point.

The identical problem situation of maintenance service information about the occurrence of complaints that are the same as a given complaint, which is analyzed and determined in analysis-determination item No. 4, is obtained by, e.g., formula: (the number of maintenance result reports of the complaint/the total number of maintenance result reports)×100. Assume that the calculation result of this formula is X4%. The PC section 17 calculates a point on the basis of a table 35 shown in FIG. 7 that shows points calculated from the value X4. When X4≦0.9, the PC section 17 calculates 1 point. When 1≦X4≦3, the PC section 17 calculates 2 points. When 4≦X4≦6, the PC section 17 calculates 3 points. When 7≦X4≦10, the PC section 17 calculates 4 points. When 11≦X4, the PC section 17 calculates 5 points.

The setup report situation about the occurrence of complaints that are the same as a given complaint, which is analyzed in analysis-determination item No. 5, is obtained by, e.g., formula: (the number of setup reports of the complaint/the total number of setup reports)×100. Assume that the calculation result of this formula is X5%. The PC section 17 calculates a point on the basis of a table 36 shown in FIG. 8 that shows points calculated from the value X5. When X5≦2.4, the PC section 17 calculates 1 point. When 2.5≦X5≦4.95, the PC section 17 calculates 2 points. When 5.0≦X5≦7.4, the PC section 17 calculates 3 points. When 7.5≦X5≦9.9, the PC section 17 calculates point. When 10.0≦X5, the PC section 17 calculates 5 points.

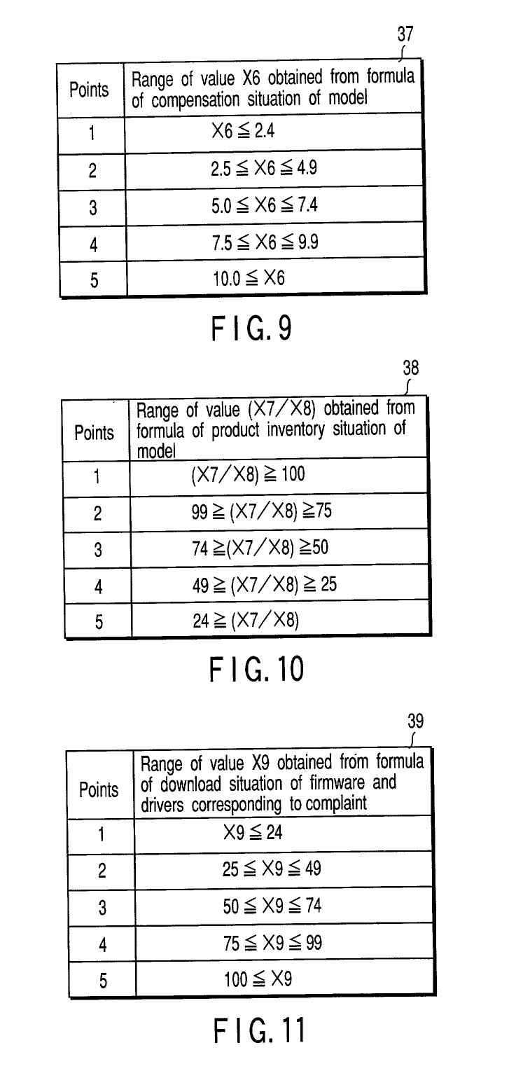

The compensation situation of a defective product, which is analyzed and determined in analysis-determination item No. 6, is obtained by, e.g., formula: (the total amount of compensation of the product/the total amount of compensation of all products)×100. Assume that the calculation result of this formula is X6%. The PC section 17 calculates a point on the basis of a table 37 shown in FIG. 9 that shows points calculated from the value X6. When X6≦2.4, the PC section 17 calculates 1 point. When 2.5≦X6≦4.9, the PC section 17 calculates 2 points. When 5.0≦X6≦7.4, the PC section 17 calculates 3 points. When 7.5≦X6≦9.9, the PC section 17 calculates 4 points. When 10.0≦X6, the PC section 17 calculates 5 points.

The product sales situation and inventory situation of a defective product for the previous month, which is analyzed and determined in analysis-determination item No. 7, is obtained by, e.g., formula: (the sales record of the product in a month/the sales forecast of the product in a month)×100. Assume that the calculation result of this formula is X7%. The PC section 17 calculates a point on the basis of a table 38 shown in FIG. 10 that shows points calculated from the value X7. When X7≧100, the PC section 17 calculates 1 point. When 99≧X7≧75, the PC section 17 calculates 2 points. When 74≧X7≧50, the PC section 17 calculates 3 points. When 49≧X7≧25, the PC section 17 calculates 4 points. When 24≧X7, the PC section 17 calculates 5 points.

The product sales situation and inventory situation of a defective product for the total period, which is analyzed and determined in analysis-determination item No. 8, is obtained by, e.g., formula: (the sales record of the product in the total period/the sales forecast of the product in the total period)×100. Assume that the calculation result of this formula is X8%. The PC section 17 calculates a point in the same value range as that shown in FIG. 10 for the above-described product sales situation and inventory situation for the previous month.

The download situation of firmware and drivers corresponding to a complaint, which is analyzed and determined in analysis-determination item No. 9, is obtained by, e.g., formula: (the number of download of firmware and drivers corresponding to the complaint/the number of delivered products)×100. Assume that the calculation result of this formula is X9%. The PC section 17 calculates a point on the basis of a table 39 shown in FIG. 11 that shows points calculated from the value X9. When X9≦24, the PC section 17 calculates 1 point. When 25≦X9≦49, the PC section 17 calculates 2 points. When 50≦X9≦74, the PC section 17 calculates 3 points. When 75≦X9≦99, the PC section 17 calculates 4 points. When 100≦X9, the PC section 17 calculates 5 points.

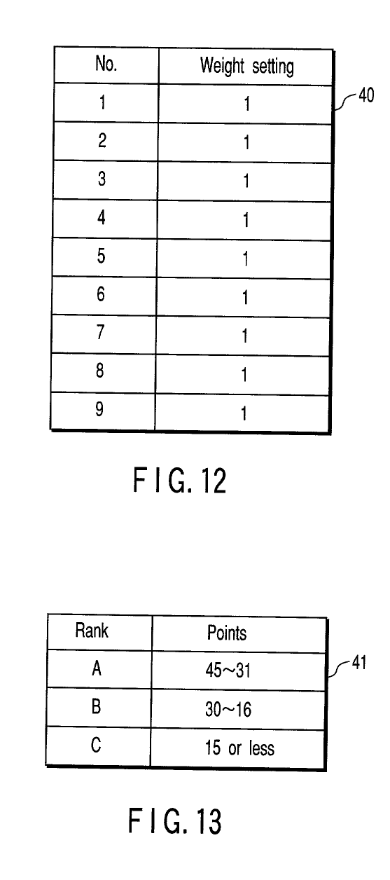

The WE section 18 can set a weight for each analysis-determination item to calculate a point in the above-described way. This weighting is done by, e.g., changing settings in a weight setting table 40 as shown in FIG. 12. In this embodiment, the weights for all analysis-determination items are uniformly set to 1. For example, when the weight for analysis-determination item No. 1 is set to 2, the PC section 17 doubles one of points 1 to 5 calculated from the analysis-determination item. The weight can be changed by the operator in the technical service department.

The PC section 17 also totals the points calculated in the above-described manner for the respective analysis-determination items to calculate the total points.

The RA section 19 assigns a rank to a complaint report on the basis of a rank assignment table 41 shown in FIG. 13 from the total point calculated by the PC section 17. As shown in the rank assignment table 41, assume that ranks A, B, and C are assigned in descending order of degrees of importance. When the total point is 45 to 31, the RA section 19 assigns rank A to the complaint report. When the total point is 30 to 16, the RA section 19 assigns rank B to the complaint report. When the total point is 15 or less, the RA section 19 assigns rank C to the complaint report. For this rank assignment table 41, the number of ranks or the point range for rank assignment can freely be changed by operator's setting. When a weight is set to 2 or more, the maximum point is 45 or more.

When the operator has changed settings in the rank assignment table 40 for weighting, the PRC section 20 calculates the total point by totaling points calculated for the respective analysis-determination items, which are obtained by changing the weight settings and divides the total points by the number of set ranks to change the point range for rank assignment in the rank assignment table 41.

The flow of a complaint report in the rank assignment system 1 will be described next. When the terminal apparatus 3, i.e., web user inquires about a complaint, this inquiry is supplied to the CH section 13 through the SIP section 11 as a complaint report. The CH section 13 checks the KB section 14 for a solution to the complaint of the received complaint report. If a solution is present, the CH section 13 receives the solution held by the KB section 14. If no solution is detected by checking the KB section 14, the CH section 13 supplies the complaint report to the PC section 17. Upon receiving the complaint report, the PC section 17 calculates, for the complaint specified by the complaint report, a point on the basis of the product information held by the MDB section 15 and weight settings by the WE section 18 and totals the points calculated for the respective analysis-determination items. The RA section 19 assigns a rank to the complaint report on the basis of the rank assignment table 41 from the total point calculated by the PC section 17. The rank assignment system 1 supplies the complaint report with the assigned rank to the product technology department.

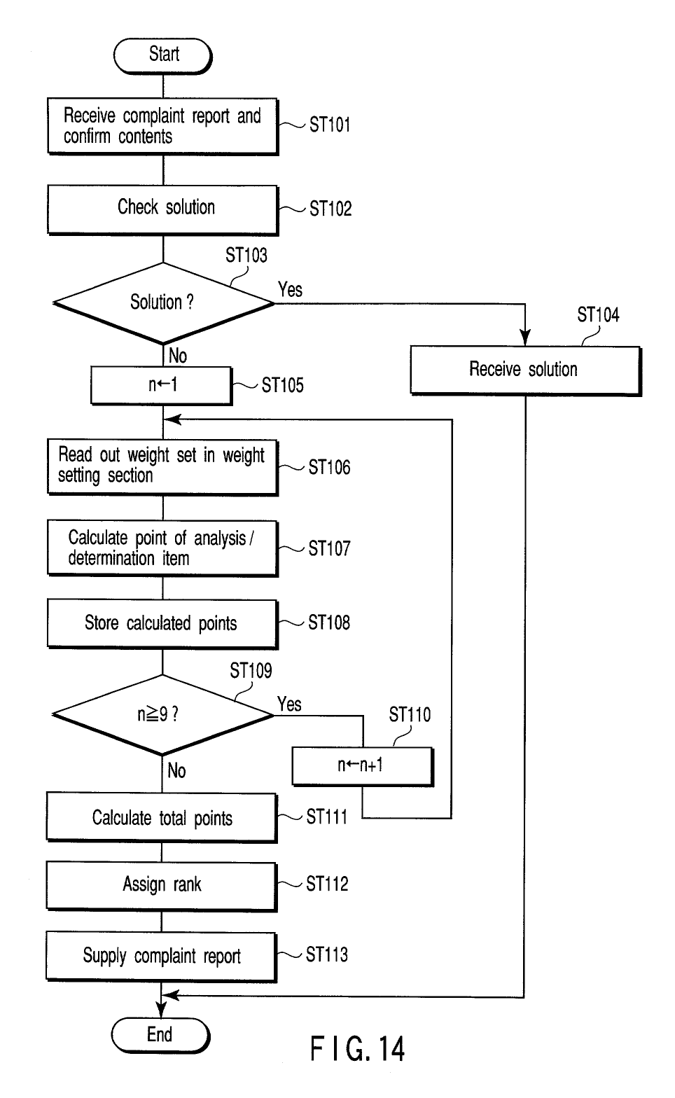

A case wherein the rank assignment system having the above configuration is applied to the technical service hierarchical structure shown in FIG. 1 will be described below. In this embodiment, only local head office can access the rank assignment system 1 through the Internet 2. FIG. 14 is a flowchart showing the flow of processing of system 1 to assign a rank for a complaint report input to the web page provided to the customer terminal 3 by the operator in the local head office.

In step ST101, upon receiving a complaint report, the contents of the complaint report are confirmed. It is checked in step ST102 whether a solution to the complaint is present. If it is determined in step ST103 that a solution is present in the database, the solution is received from the KB section 14 in step ST104.

On the other hand, if it is determined in step ST103 that no solution is present, the points of the complaint report is calculated in steps ST105 to ST110.

First, in step ST105, a variable N representing the No. (number) of analysis-determination item is set to 1. In step ST106, the weight set for analysis-determination item No. 1 is read out. In step ST107, points are calculated on the basis of the readout weight and analysis-determination of the service part delivery situation. In step ST108, the calculated point is temporarily stored in, e.g., a memory.

Next, it is determined in step ST109 whether the variable N is 9 or more. If it is determined in step ST109 that the variable is less than 9, the variable N is incremented by one in step ST110. The processing in steps ST106 to ST109 is repeated until it is determined that the variable N is 9 or more. With this processing, points of all the respective analysis-determination items are calculated.

If it is determined in step ST109 that the variable is 9 or more, in step ST111, the points of the analysis-determination items, which are stored in the memory, are totaled to calculate the total points. In step ST112, a rank is assigned to the complaint report on the basis of the calculated total point and rank assignment table 41. In step ST113, the complaint report with the assigned rank is supplied to a system device in the product technology department. To calculate the total points, SUM=0 may be set in step ST105, and the points of each analysis-determination item may be added to the current total points in step ST107. In this case, step ST111 can be omitted.

The engineer in charge in the product technology department executes support operation from a complaint report assigned rank A. The system device in the technology department transmits a solution to the technical service department. In the technical service department, an answer is prepared on the basis of the solution and returned to the local head office.

According to this embodiment, the rank assignment system 1 calculates a point for each analysis-determination item on the basis of the product information held by the MDB section 15, totals the points of all analysis-determination items, and assigns a rank to a complaint report received from the local head office as a customer on the basis of the totaled points and rank assignment table 41. For this reason, an appropriate rank that represents the degree of importance of the layer-shifted complaint can automatically be assigned to the complaint report.

Hence, the engineer in charge in the product technology department can execute the support operation preferentially from a complaint with a high degree of importance, for which early complaint handling is desired in the market, in complaints layer-shifted to the technical service department.

In addition, since the technical service network is systematically managed, and the technical service department that collects information of all provided products executes processing, the quantity of information is enormous. For this reason, objective and appropriate rank assignment is possible.

Furthermore, since the operator freely changes weight settings by the WE section 18, rank assignment can be done with a weight increased on any one of the analysis-determination items regarded by the operator to have a high degree of importance.

In the above-described embodiment, the rank assignment system executes complaint handling for complaint reports related to products such as copying machines and facsimile apparatuses. However, the present invention is not limited to this.

The present invention can be applied not only to a worldwide technical service network but also to a plurality of domestic market areas in a single country. At least one of the SIP section 11, MIS section 12, CH section 13, KB section 14, MDB section 15, DWH section 16, PC section 17, WE section 18, RA section 19, and PRC section 20 of the rank assignment system 1 may be formed from a server computer in which the application software of the functions described in the above embodiment is installed from a recording medium or downloaded through a communication interface. Any recording medium such as an optical disk (e.g., a CD-ROM), magnetooptical disk (e.g., an MO), or semiconductor memory can be employed as long as it is computer-readable and capable of storing a program.

A case wherein the rank assignment system 1 receives a complaint report from the local head office has been described above. However, the present invention can also be applied to a network in which the rank assignment system receives a complaint directly from a local head office, local companies, agency, direct service organization, or dealer.

FIG. 14 is a flowchart of the system and the method according to an embodiment of invention. Each block of the flowchart, and combinations of blocks in the flowchart, can be implemented by computer program instructions. These computer program instructions may be loaded onto a computer program or other programmable apparatus to produce a machine. These computer program instructions may also be stored in a computer-readable memory that can direct a computer or other programmable apparatus to function in a particular manner. The computer program instructions may also be loaded onto a computer or other programmable apparatus to cause a series of operational steps to be performed on the computer or other programmable apparatus to produce a computer implemented process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A rank assignment system comprising:
a service information portal section which provides a web page as an input/output interface of information and receives a complaint from the web page;
a master database section which holds product information related to a sales product;
a point calculation section which calculates points for each analysis-determination item used to analyze and determine the complaint, on the basis of a result obtained by analyzing the product information and a preset condition for the result, and totals the points of the analysis-determination items; and
a rank assignment section which assigns a rank to the complaint on the basis of the points totaled by said point calculation section and a preset point range.

2. A system according to claim 1, further comprising a weight setting section which sets for each analysis-determination item a weight on the point calculated on the basis of the preset condition for the result from the result obtained by analyzing the product information.

3. A system according to claim 2, further comprising a point range change section which automatically changes the point range for rank assignment when setting of said weight setting section is changed.

4. A system according to claim 1, wherein one of the analysis-determination items is a delivery situation of a defective service part.

5. A system according to claim 4, wherein the product information analysis result is obtained from the number of delivered service parts and the number of delivered products using the parts.

6. A system according to claim 1, wherein one of the analysis-determination items is a machine market operation reliability of a defective product.

7. A system according to claim 6, wherein the product information analysis result is obtained from the mean number of service call occurrence interval copies of the defective product and the mean number of service call occurrence interval copies of another product.

8. A system according to claim 1, wherein one of the analysis-determination items is a report situation to a call center of the occurrence of complaints that are the same as a given complaint.

9. A system according to claim 8, wherein the product information analysis result is obtained from the number of reports of complaints that are the same as the given complaint and the total number of reports.

10. A system according to claim 1, wherein one of the analysis-determination items is an identical problem situation of maintenance service information about the occurrence of complaints that are the same as a given complaint.

11. A system according to claim 10, wherein the product information analysis result is obtained from the number of maintenance result reports of the complaint and the total number of maintenance result reports.

12. A system according to claim 1, wherein one of the analysis-determination items is a setup report situation about the occurrence of complaints that are the same as a given complaint.

13. A system according to claim 12, wherein the product information analysis result is obtained from the number of setup reports of the complaint and the total number of setup reports.

14. A system according to claim 1, wherein one of the analysis-determination items is a compensation situation of a defective product.

15. A system according to claim 14, wherein the product information analysis result is obtained from a total amount of compensation of the defective product and a total amount of compensation of all products.

16. A system according to claim 1, wherein one of the analysis-determination items is a product sales situation and inventory situation of a defective product in a predetermined period.

17. A system according to claim 16, wherein the product information analysis result is obtained from a sales record of the defective product in the predetermined period and a sales forecast of the defective product in the same period as the predetermined period.

18. A system according to claim 1, wherein one of the analysis-determination items is a download situation of firmware and drivers corresponding to a complaint.

19. A system according to claim 18, wherein the product information analysis result is obtained from the number of download of the firmware and drivers corresponding to the complaint and the number of delivered products which are defective.

20. A rank assignment method comprising:
receiving input of a complaint from a web page which is provided as an input/output interface of information;
calculating points for each analysis-determination item used to analyze and determine the complaint, on the basis of a result obtained by analyzing product information related to a sales product, which is held by a master database section, and a preset condition for the result;
totaling the points calculated for the analysis-determination items; and
assigning a rank to the complaint on the basis of the totaled points and a preset point range.

21. A method according to claim 20, further comprising changing for each analysis-determination item setting of weighting on the point calculated on the basis of the preset condition for the result from the result obtained by analyzing the product information.

22. A method according to claim 21, further comprising, when setting of weighting is changed, automatically changing the point range for rank assignment.

23. A method according to claim 20, wherein one of the analysis-determination items is a delivery situation of a defective service part.

24. A method according to claim 20, wherein one of the analysis-determination items is a machine market operation reliability of a defective product.

25. A method according to claim 20, wherein one of the analysis-determination items is a report situation to a call center of the occurrence of complaints that are the same as a given complaint.

26. A method according to claim 20, wherein one of the analysis-determination items is an identical problem situation of maintenance service information about the occurrence of complaints that are the same as a given complaint.

27. A method according to claim 20, wherein one of the analysis-determination items is a setup report situation about the occurrence of complaints that are the same as a given complaint.

28. A method according to claim 20, wherein one of the analysis-determination items is a compensation situation of a defective product.

29. A method according to claim 1, wherein one of the analysis-determination items is a product sales situation and inventory situation of a defective product in a predetermined period.

30. A method according to claim 1, wherein one of the analysis-determination items is a download situation of firmware and drivers corresponding to a complaint.

31. A computer program product for rank assignment, comprising:
a computer-readable storage medium having computer-readable program code means embodied in said medium, said computer-readable program code means comprising:
computer readable program code means for receiving input of a complaint from a web page which is provided as an input/output interface of information;
computer readable program code means for calculating points for each analysis-determination item used to analyze and determine the complaint, on the basis of a result obtained by analyzing product information related to a sales product, which is held by a master database section, and a preset condition for the result;
computer readable program code means for totaling the points calculated for the analysis-determination items; and
computer readable program code means for assigning a rank to the complaint on the basis of the totaled points and a preset point range.

32. A computer program product according to claim 31, further comprising computer readable program code means for changing setting of weighting on the points calculated on the basis of the preset condition for the result from the result obtained by analyzing the product information for each analysis-determination item.

33. A computer program product according to claim 32, further comprising computer readable program code means for, when setting of weighting is changed, automatically changing the point range for rank assignment.

34. A computer program product according to claim 31, wherein one of the analysis-determination items is a delivery situation of a defective service part.

35. A computer program product according to claim 31, wherein one of the analysis-determination items is a machine market operation reliability of a defective product.

36. A computer program product according to claim 31, wherein one of the analysis-determination items is a report situation to a call center of the occurrence of complaints that are the same as a given complaint.

37. A computer program product according to claim 31, wherein one of the analysis-determination items is an identical problem situation of maintenance service information about the occurrence of complaints that are the same as a given complaint.

38. A computer program product according to claim 31, wherein one of the analysis-determination items is a setup report situation about the occurrence of complaints that are the same as a given complaint.

39. A computer program product according to claim 31, wherein one of the analysis-determination items is a compensation situation of a defective product.

40. A computer program product according to claim 31, wherein one of the analysis-determination items is a product sales situation and inventory situation of a defective product in a predetermined period.

41. A computer program product according to claim 31, wherein one of the analysis-determination items is a download situation of firmware and drivers corresponding to a complaint.
